(19) United States
(12) Patent Application Publication
(10) Pub. No.: US 2024/0136853 A1
(43) Pub. Date: Apr. 25, 2024

(54) INDUCTIVELY POWERED CHARGING PLATFORM

(71) Applicant: HumanTouch Computers Co., Wimberley, TX (US)

(72) Inventor: Scott Baker, Wimberley, TX (US)

(21) Appl. No.: 17/969,565

(22) Filed: Oct. 18, 2022

(51) Int. Cl. H02J 50/00; H02J 7/00; H02J 50/10

(52) U.S. Cl. CPC H02J 50/005; H02J 7/0044; H02J 50/10

(57) ABSTRACT

In one aspect, a charging device includes a plug, a platform defining one or more planar surfaces, a leg having a bottom end coupled to the plug and a top end coupled to the platform with a length measured between the top and bottom ends and a minimum width that is less than one-third of a width of the platform, and one or more chargers. The plug is configured to be received into a receptacle on a wall such that the one or more chargers are in electrical communication with the receptacle, the leg extends between the receptacle and the platform along the wall, and the platform projects outwardly from the wall such that each of the one or more planar surfaces is substantially perpendicular to the wall and the width of the platform is substantially parallel to the wall. Other aspects and features are described.

### TECHNICAL FIELD

The present invention relates generally to charging devices, and more particularly but without limitation, to charging devices that can be mounted against a wall to charge electronic devices.

### BACKGROUND

Charging devices are often comprised of one or more connectors (e.g., plug(s), jack(s), etc.) and a cord. Charging devices are designed to provide electrical power to electronic devices. Often, when charging, the user is required to rest the electronic device on the floor in proximity to an electrical socket or power source. If the user prefers, the electronic device can be placed on a piece of furniture, such as a desk or a nightstand. This design still requires that a cord is separately plugged into the wall and often connected to the device, displaying a cord in an unsightly manner. Cords can produce a messy look in any area of the house. Additionally, cords and plugs can wear out and also prevent safety hazards, such as from electrocution and tripping.

Presently, furniture, such as end tables or sofas, with charging capabilities are commercially available. The furniture may include plugs for wired charging or pads for wireless charging. While this furniture provides a solution for unsightly cords, the item itself is large, bulky, and often expensive. In certain homes or buildings, it may not be feasible to place the furniture in an area that is both accessible to a plug and readily allows for the user to charge his or her device. Moreover, if a charging standard changes, the entire piece of furniture needs to replaced or may be useless. In addition, charging stations and mats are also available for charging electronic devices. However, such charging devices require a piece of furniture or flat surface to put the charging station.

### SUMMARY

The following summarizes some aspects of the present disclosure to provide a basic understanding of the discussed technology. This summary is not an extensive overview of all contemplated features of the disclosure and is intended to neither identify key or critical elements of the aspects of the disclosure nor to delineate the scope of any or all aspects of the disclosure in summary form as a prelude to the more detailed description.

The charging devices described herein do not require a number of unsightly cords or bulky furniture. The charging devices described herein provide a wireless charging platform that is raised from the electrical plug, while concealing the wires used to power the platform. The charging device can provide for accessible, wireless charging throughout a home without detracting from the aesthetic appeal or requiring bulky dedicated furniture. The charging devices described herein can be moved around from room to room and can be replaced or upgraded for new charging standards. Additionally, the charging device described herein provide increase safety and flexibility while also reducing cost as compared to previous charging solutions.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The terms “substantially” and “approximately” are each defined as largely but not necessarily wholly what is specified—and includes what is specified; e.g., substantially or approximately 90 degrees includes 90 degrees and substantially or approximately parallel includes parallel—as understood by a person of ordinary skill in the art. In any disclosed embodiment, the terms “substantially” and “approximately” may be substituted with “within [a percentage] of” what is specified, where the percentage includes 0.1, 1, 5, and 10 percent.

The terms “comprise” and any form thereof such as “comprises” and “comprising,” “have” and any form thereof such as “has” and “having,” and “include” and any form thereof such as “includes” and “including” are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

Any embodiment of any of the apparatuses, systems, and methods can consist of or consist essentially of—rather than comprise/include/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Further, a device or system that is configured in a certain way is configured in at least that way, but it can also be configured in ways other than those specifically described.

The feature or features of one embodiment may be applied to other embodiments, even though not described or illustrated, unless expressly prohibited by this disclosure or the nature of the embodiments.

Some details associated with the embodiments described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. Views in the figures are drawn to scale, unless otherwise noted, meaning the sizes of the depicted elements are accurate relative to each other for at least the embodiment in view.

FIG. 1A is a perspective view of a first embodiment of a charging device.

FIGS. 1B-1D are back, top, and front views, respectively of the charging device of FIG. 1A.

FIGS. 2A and 2B are front views of three- and two-prong wall receptacles, respectively.

FIG. 3 is a perspective view of the charging device of FIG. 1A coupled to a wall receptacle and mounted against a wall.

FIGS. 4A-4B are bottom and side views, respectively, of a bracket used to reinforce a leg of the charging device of FIG. 1A.

FIG. 4C is a side view of fasteners used to secure the brackets of FIGS. 4A-4C to the wall.

FIG. 4D is a front view of the charging device of FIG. 1A mounted against a wall and further secured to the wall by the bracket of FIGS. 4A-4C.

FIG. 5 is a front view of an adhesive strip on a leg of the charging device of FIG. 1A.

FIGS. 6 and 7 are front and top views, respectively, of a second embodiment of a charging device including one or more receptacles configured for wired charging.

FIG. 8 is a front view of a third embodiment of a charging device where a leg of the charging device has a shorter length as compared to a width of a top of the charging device.

FIGS. 9A-9C are perspective, front, and sectional views, respectively, of a fourth embodiment of a charging device that includes one or more compartments configured to receive and support one or more electronic devices.

FIG. 10 is a front view of a fifth embodiment of a charging device that has a tapered portion spanning the entirety of leg length.

FIGS. 11A and 11B are perspective and front views, respectively, of a sixth embodiment of a charging device where a platform of the charging device includes three planar surfaces.

FIG. 12A is a top view of a seventh embodiment of a charging device that includes one or more charging stands.

FIGS. 12B and 12C are side views and illustrate that the one or more charging stands of FIG. 12A are moveable between a first position in which the stand is substantially parallel to planar surface (FIG. 12B) and a second position in which the surface of the stand is angularly disposed relative to the planar surface (FIG. 12C).

FIG. 13 is a perspective view of an eighth embodiment a charging device including fixed charging stands.

FIG. 14 is a perspective view of a ninth embodiment of a charging device that includes speakers.

### DETAILED DESCRIPTION

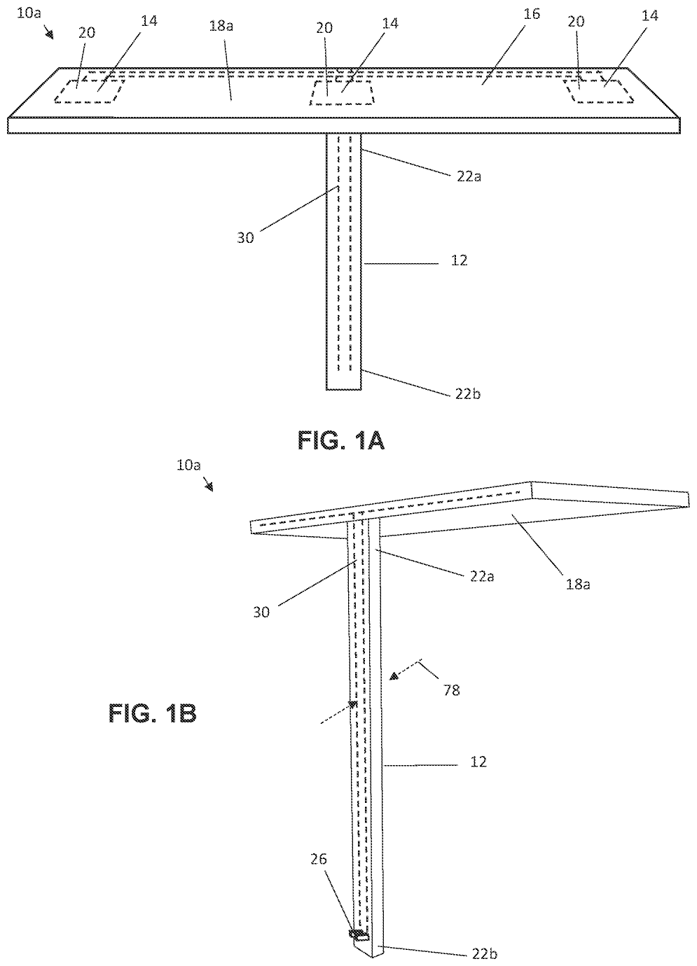

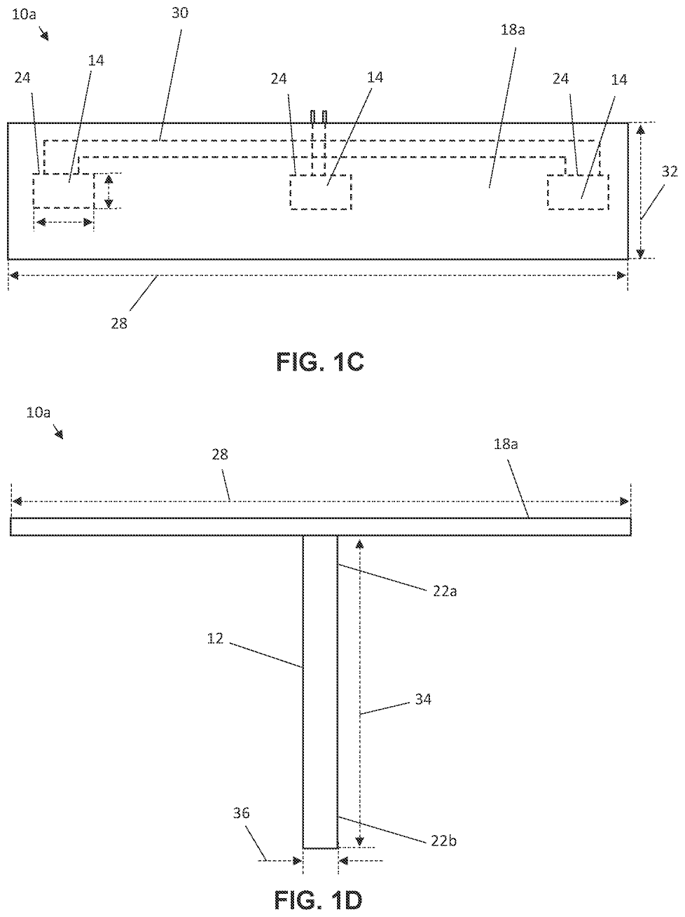

Referring to FIGS. 1A-1D, shown is a first embodiment (charging device 10a) of the present charging devices. Charging device 10a can comprise a platform 16 defining one or more planar surfaces 18a and a leg 12 having a top end 22a and a bottom end 22b, the top end coupled to the platform. Charging device 10a can also comprise one or more chargers 14, such as greater than or equal to any one of, or between any two of, 1, 2, 3, 4, 5, 6, 7, 8, 9, or 10 chargers, each of which can be configured to deliver electrical power to an electronic device (e.g., a mobile phone, tablet, watch, computer, headphones, and/or the like). Each of charger(s) 14 can be in electrical communication with a plug 26 coupled to bottom end 22b of leg 12—via, for example, one or more wires 30—such that electrical power received by the plug can be transmitted to an electronic device interfacing with one of the charger(s).

Charging device 10a can be configured to support one or more electronic devices while charger(s) 14 deliver power to them, while also providing a working surface for a user. As shown, for example, platform 16 has multiple chargers 14 and is configured to support multiple electronic devices, each of which can interface with (e.g., be placed on, for inductive chargers as discussed below) a respective one of the chargers, which allows them to be charged simultaneously. Platform 16 can have any suitable size to do so. For example, a surface area of planar surface(s) 18a can be greater than or equal to any one of, or between any two of, 0.5, 1, 2, 3, 4, 5, 6, 7, 8, 9, 10, 11, or 12 square feet (e.g., between 2 and 8 square feet). To further illustrate, a width 28 of platform 16 can be greater than or equal to any one of, or between any two of, 1, 1.5, 2, 2.5, 3, 3.5, 4, 4.5, 5, 5.5, or 6 feet and a length 32 of platform 16 can be greater than or equal to any one of, or between any two of, 0.5, 0.75, 1.0, 1.25, 1.5, 1.75, or 2.0 feet.

Charging device 10a can have any suitable charger(s) 14 to deliver power to one or more electronic devices. For example, at least one (up to and including each) of charger(s) 14 can be an inductive charger 20 configured to inductively charge a device disposed on it. An inductive charger 20 can comprise, for example, an induction coil configured to conduct an alternating current therethrough and thereby generate a magnetic field having a time-varying strength. When an electronic device having an induction coil is disposed on inductive charger 20, the inductive charger's time-varying magnetic field may induce an alternating current in the electronic device's coil. The induced alternating current can pass through a rectifier of the electronic device for conversion to a direct current, which can charge a battery of the electronic device and/or power one or more of the electronic device's components. In this way, an inductive charger 20 may transmit electrical power to an electronic device that is not conductively connected to the inductive charger.

Each of inductive charger(s) 20 can be shaped and dimensioned to permit inductive charging of various types of electronic devices, for example computers, tablets, phones, watches, headphones, and/or the like as discussed above, disposed on a charging surface 24 (e.g., that overlies or is defined by the inductive charger). As shown, for example, charging surface 24 may be rectangular, but in other embodiments the charging surface can be square, triangular, or otherwise polygonal, or circular, elliptical, or otherwise rounded. Furthermore, a surface area of charging surface 24 can be greater than or equal to any one of, or between any two of, 0.01, 0.5, 1, 2, 3, 4, 5, 6, 7, 8, 9, or 10 square feet (e.g., between 0.1 and 2 square feet) and/or a maximum transverse dimension (e.g., length or diameter) of the charging surface can be greater than or equal to any one of, or between any two of, 1, 2, 3, 4, 5, 6, 7, 8, 9, 10, 11, or 12 inches. The inductive charger(s) 20 may include an induction unit (not shown in FIGS. 1A-ID) as known in the art. In some implementations, an induction unit may include, for example, one or more coils, one or more receivers, circuitry (e.g., a controller), and wires. An inductive charger 20 (e.g., an induction unit thereof) may be configured to receive current (AC) at the one or more coils via the wires and generate a magnetic field, which can be used to generate current in (e.g., charge) a receiving device.

As shown, at least one of inductive charger(s) 20 can be coupled to platform 16 to define one or more charging surfaces 24 on the platform, e.g., such that each of those inductive charger(s) is configured to inductively charge a device disposed on one of the platform's planar surface(s) 18a. To allow a user to continue to use and/or access to an electronic device that is receiving power from one of such inductive charger(s) 20, charging device 10a can be configured to allow platform 16 (e.g., at least one of its planar surface(s) 18a) to be positioned at a traditional desk height (e.g., between approximately 28 and 30 inches above a ground surface) or higher (e.g., for use as a standing desk). Charging device 10a's leg 12 can facilitate such positioning (e.g., when plug 26 is received in an electrical receptacle positioned close to the ground surface, discussed in further detail below). By way of example, a length 34 of leg 12 (e.g., measured in a direction aligned with an axis that extends between the leg's top and bottom ends 22a and 22b) can be greater than or equal to any one of, or between any two of, 1, 1.5, 2, 2.5, 3, 3.5, 4, or 4.5 feet.

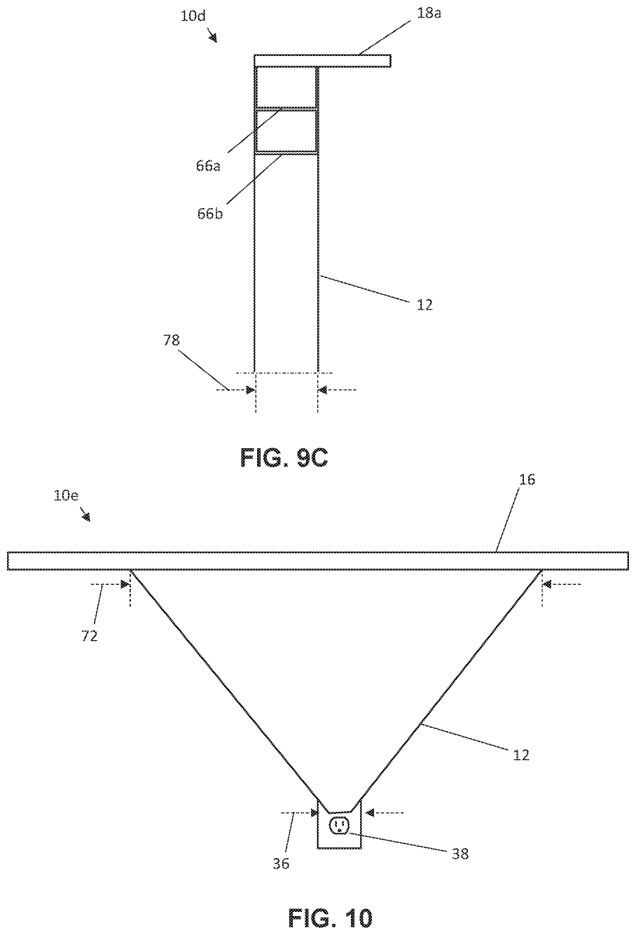

Further, leg 12 can provide discrete coverage of wire(s) 30 that can place charger(s) 14a in electrical communication with plug 26, while also supporting platform 16 so that the platform may be used as a working surface. To do so, leg 12 can be relatively narrow. By way of example, a minimum width 36 of the leg 12 can be less than or equal to any one of, or between any two of, ⅓rd, ¼th, ⅙th, or 1/12th of platform 16's width 28 (e.g., each measured perpendicularly to the leg's length 34) and/or less than or equal to any one of, or between any two of, ⅕th, 3/20th, 1/10th, or 1/20th of the leg's length, such as less than or equal to any one of, or between any two of, 6. 5.5, 5, 4.5, 4, 3.5, 3, 2.5, 2, 1.5, 1, or 0.5 inches (e.g., between 0.60 and 2.75 inches). Leg 12 can also be relatively thin, with a minimum thickness 78 of the leg, measured perpendicularly to the leg's width and length 34, being less than or equal to any one of, or between any two of, ⅓rd, ¼th, ⅙th, or 1/12th of platform 16's length 32, such as less than or equal to any one of, or between any two of, 4, 3.5, 3, 2.5, 2, 1.5, 1, or 0.5 inches. Such a narrow and thin leg 12—whose width and thickness can, but need not (as discussed below with respect to FIGS. 9A-9C and 10), be substantially constant along its length 34—can still accommodate wire(s) 30, which can be disposed (e.g., embedded) within the leg (and optionally platform 16).

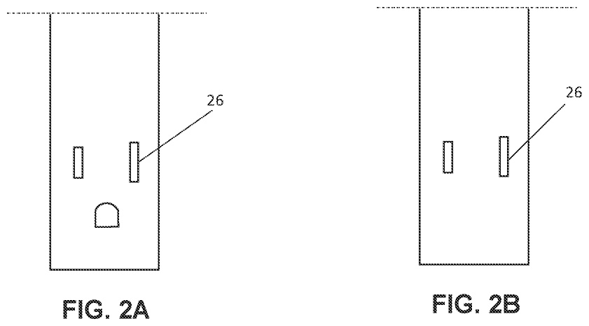

Referring to FIGS. 2A and 2B, charging device 10a's plug 26 can be configured to be received into a wall receptacle such that charger(s) 14, via wire(s) 30 and the plug, are in electrical communication with the receptacle, allowing electrical power to be transmitted from the receptacle to electronic device(s) interfacing with the charger(s). As shown, plug 26 can comprise three prongs configured to be received into a three-slot receptacle (e.g., a Type B plug) (FIG. 2A) or two prongs configured to be received into a two-slot receptacle (e.g., a Type A plug) (FIG. 2B). In other embodiments, however, plug 26 can have any suitable number of prongs in any suitable arrangement to allow it to be received into any suitable power receptacle (e.g., a receptacle used in a given locality).

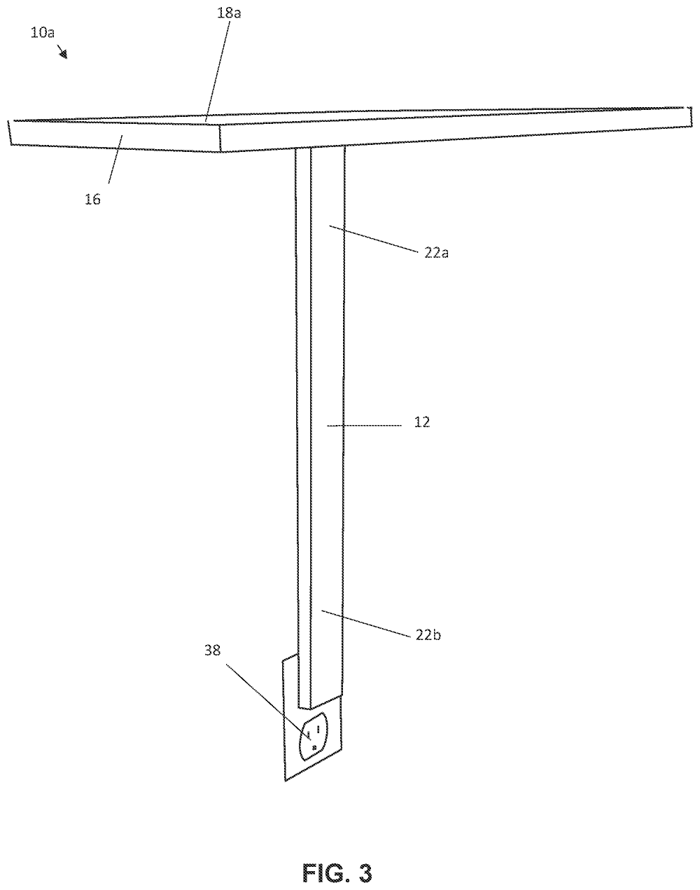

Referring to FIG. 3, charging device 10a can be mounted against a wall when plug 26 is received in wall receptacle 38, and need not have support on a ground surface. For example, as shown leg 12 can run along the wall between receptacle 38 and platform 16 to provide support to the platform, whose weight can thus be at least partially be supported by the prongs of plug 26 that is coupled to the leg's bottom end 22b and is received in the receptacle. Thus, unlike the plugs in prior charging tables, plug 26 can provide both structural support and electrical power for charging device 10a. Furthermore, planar surface(s) 18a of platform 16 can project outwardly from the wall such that they are each substantially perpendicular to the wall, with width 28 of the platform being substantially parallel to the wall. As such, a user can comfortably use platform 16—which is positioned at a readily accessible height as discussed above—and access electronic device(s) disposed thereon, which can be charged on the platform.

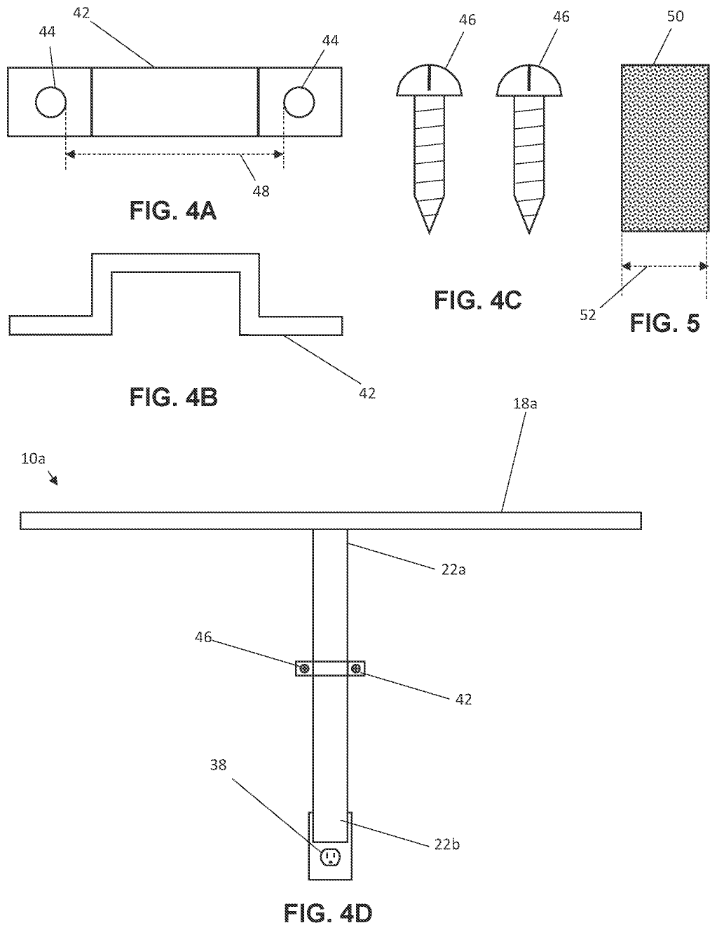

Referring to FIGS. 4A-4D and 5, charging device 10a may further comprise one or more reinforcements to provide additional support to leg 12 and thus platform 16 when plug 26 is received in receptacle 38. Charging device 10a's leg 12 can be further reinforced by, for example, one or more brackets 42 as shown in FIGS. 4A-4D, each of which can each extend across the leg in a direction perpendicular to the leg's length 34 to support it. Each of bracket(s) 42 can comprise two openings 44, and a distance 48 between the two openings can larger than minimum width 36 of leg 12. Thus, when bracket 42 extends across leg 12 in a direction perpendicular to length 34 of the leg, the bracket can be secured to (and accordingly hold the leg against) the wall with fasteners 46 that are each received through a respective one of openings 44. Each of bracket(s) 42 may be placed at any point along length 34 of leg 12 to provide support, such as the midpoint between top end 22a and bottom end 22b or at a point closer to the top end than to the bottom end.

Additionally or alternatively, charging device 10a can comprise one or more adhesive strips 50 to attach and/or secure leg 12 to the wall. Adhesive strip(s) 50 can be disposed between leg 12 and the wall to adhere the leg thereto, and they can each have a width 52 that is less than a width of the leg where the strip is positioned (e.g., less than the leg's minimum width 36) such that the strip remains hidden behind the leg.

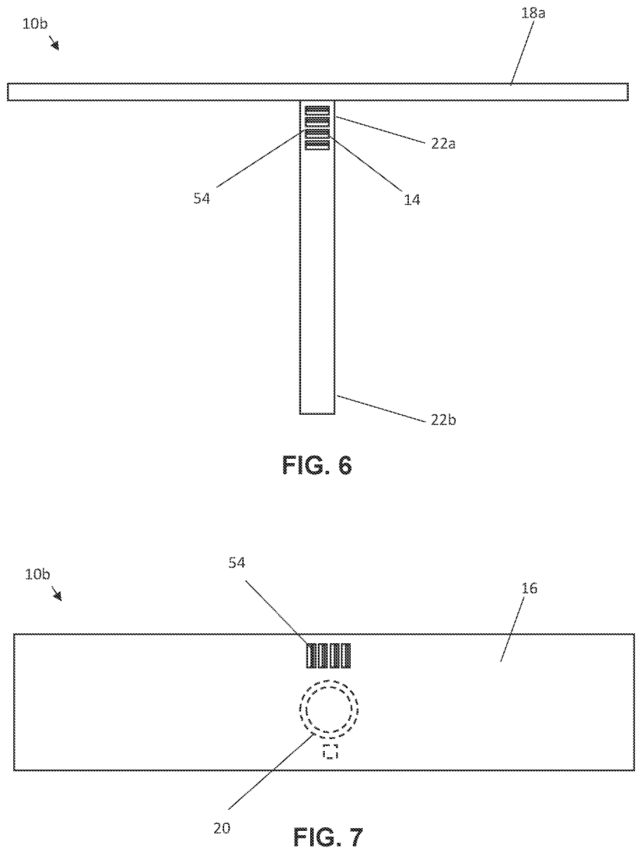

In such implementations where the charging device 10a comprises inductive charger(s) 20, some users may prefer to power electronic devices using wired charging, and some electronic devices do not have inductive charging capabilities. Referring to FIGS. 6 and 7, shown is a second embodiment (charging device 10b) of the present charging devices that is substantially the same as charging device 10a, the primary exception being that charging device 10b's charger(s) 14 comprise one or more receptacle(s) 54, each configured for wired charging. Each of receptacle(s) 54 can be configured to deliver electric power to an electronic device via a wire having a first plug received in the receptacle and a second plug received in the electronic device.

As shown, each of receptacle(s) 54 can be positioned closer to top end 22a of leg 12 than to bottom end 22b of the leg, allowing access to the receptacle(s) for charging. For example, each of receptacle(s) 54 can be coupled to leg 12 of charging device 10b (e.g., at upper end 22a) (FIG. 6). Additionally or alternatively, one or more of receptacle(s) 54 can be disposed on one of planar surface(s) 18a of platform 16 (FIG. 7). Preferably, charging device 10b's charger(s) 14 also comprise one or more inductive charger(s) 20 (e.g., on platform 16) as discussed above, which provides a user with at least two options for charging electronic devices. Receptacle(s) 54 can each be configured to receive the plug of any suitable charging cable, such the plug of a Mini-B, USB C, USB-B, or USB-A cable.

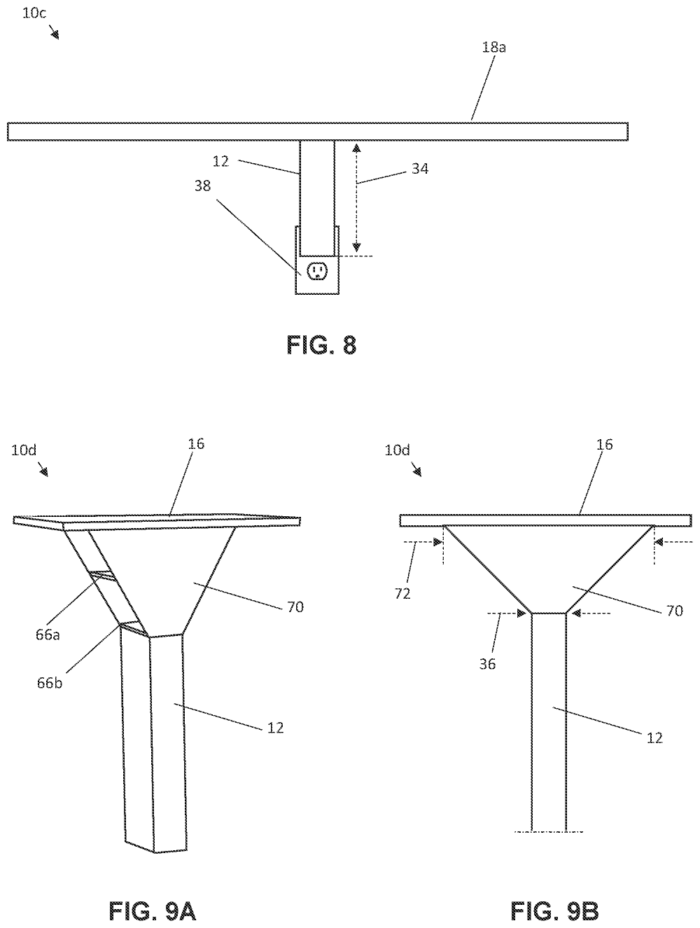

Some of the present charging devices may have different geometries to define a user-friendly work surface. Shown in FIG. 8, for example, is a third embodiment 10c of the present charging devices that is substantially the same as charging device 10a, the primary exception being that the leg 12 of the charging device 10c has a shorter length 34. Some wall receptacles(s) 38 are placed higher than others, such as above a counter or at a height that is greater than the typical 12 inches from a ground surface. With leg 12 of a shorter length 34, platform 16 can be positioned at a readily-accessible height when plug 26 is received in one of such above-normal-height receptacles 38. By way of example, length 34 of the leg 12 can be less than or equal to any one of, or between any two of, 2.5, 2, 1.5, 1, or 0.5 feet.

Some of the present charging devices can be configured to provide additional storage and charging capabilities. Referring to FIGS. 9A-9C, shown is a fourth embodiment (charging device 10d) of the present charging devices that is substantially the same as charging device 10a, the primary exception being that charging device 10d includes one or more compartments 66 that can each be inside a housing unit 70 and can each be configured to receive and support one or more electronic devices. Charging device 10d may comprise any suitable number of compartments 66; as shown, for example, the charging device has two compartments (e.g., an upper compartment disposed above a lower compartment). At least one-up to and including each—of compartment(s) 66 can include one or more of charging device 10d's charger(s) 14 (e.g., on a surface in the compartment that supports the electronic device), such as one or more inductive chargers 20 and/or one or more receptacle(s) 54 as discussed above. In this manner, charging device 10d can store and charge electronic devices in compartment(s) 66 such that the devices do not occupy usable space on platform 16.

Each of compartment(s) 66 can be positioned closer to top end 22a of leg 12 than to the leg's bottom end 22b to allow access thereto. For example, housing unit 70 can be defined by a portion of leg 12 at top end 22a and can be coupled to platform 16.

For added stability and/or to provide room for electronic device(s) in housing unit 70 (if included), at least a portion of leg 12 may be larger than that of charging device 10a whose leg, as shown, has a substantially constant width. For example, the width of leg 12, instead of being substantially constant, can vary along length 34 of the leg, such as in a tapered portion that is coupled to platform 16 and (if compartment(s) 66 are included) defined housing unit 70. In the tapered portion of leg 12, the leg's width, measured perpendicular to the leg's length 34, can decrease moving along the length of the leg toward the leg's bottom end 22b. As shown, in the tapered portion, the wide of leg 12 decreases from a maximum width 72 of the leg to the leg's minimum width 36 (which can be any of the minimum widths discussed above). Maximum width 72 can be greater than or equal to, or between any two of, 1.5, 2.5, 3.0, 3.5, 4.0, 4.5, 5.0, 6.0, 7.0, 8.0, 9.0, 10, 20, or 30 times minimum width 36, such as greater than or equal to any one of, or between any two of, 6, 8, 10, 12, 14, 16, 18, 20, 22, 24, 26, 28, 30, 40, or 50 inches. As shown in FIG. 9B, the tapered portion can span less than or equal to any one of, or between any two of, 40%, 35%, 30%, 25%, 20%, or 15% of length 34 of leg 12; in the remainder of the leg, the leg's width can be substantially constant along the length thereof. However, turning to FIG. 10 that shows a substantially-similar charging device 10e, stability and/or device carrying capacity can be further promoted with the tapered portion spanning the entirety of leg 12's length 34, with maximum width 72 at top end 22a being greater than or equal to any one of, or between any two of, 60%, 70%, 80%, or 90% of platform 16's width 28.

To further account for any added load in compartment(s) 66 and/or increase the carrying capacity thereof, leg 12 of charging device 10d may also have a thickness 78, measured perpendicularly to the leg's length 34 and width, that is larger than that of the charging device 10a. For example, leg 12's thickness 78 can be greater than or equal to any one of, or between any two of, 1.5, 2.0, 2.5, 3.0, 3.5, 4.0, 4.5, 5.0, 5.5, or 6.0 inches.

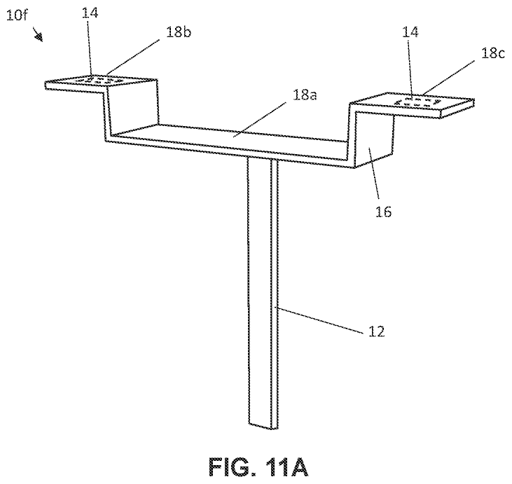

While some of the present charging devices include a platform 16 with a single planar surface 18a (e.g., as shown for devices 10a-10e), in other embodiments the platform can have multiple (e.g., two or more) planar surfaces. Referring to FIGS. 11A and 11B, for example, shown is a sixth embodiment (charging device 10f) of the present charging devices that is substantially the same as charging device 10a, the primary exception being that charging device 10f's platform 16 comprises three planar surfaces 18a-18c. At least one of planar surfaces 18a-18c need not include one of charger(s) 14 to, for example, allow use thereof as a working surface unobstructed by an electronic device that charging device 10f is charging. As shown, first planar surface 18a that is coupled to leg 12 does not include one of charger(s) 14, while second and third planar surfaces 18b and 18c do. First planar surface 18a can be disposed between second and third planar surfaces 18b and 18c, taken along a direct aligned with minimum width 36 of leg 12, such that electronic devices charging on the second and third planar surfaces are at a user's periphery. Furthermore, second planar surface 18b and third planar surface 18c can be at a different height than first planar surface 18a, e.g., can be positioned further from bottom end 22b of leg 12 than is the first planar surface, taken along a direction aligned with length 34 of the leg, which can facilitate identification of the second and third planar surfaces as charging surfaces. With first planar surface 18a serving as a working surface for a user, it can define at least a plurality of platform 16's planform area. For example, measured along platform 16's width 28, a width 82a of first planar surface 18a can be greater than or equal to any one of, or between any two of, 40%, 50%, 60%, 70%, or 80% of the platform's width and widths 82b and 82c and second and third planar surfaces 18b and 18c can each be less than or equal to any one of, or between any two of, 30%, 25%, 20%, 15%, or 10% of the platform's width.

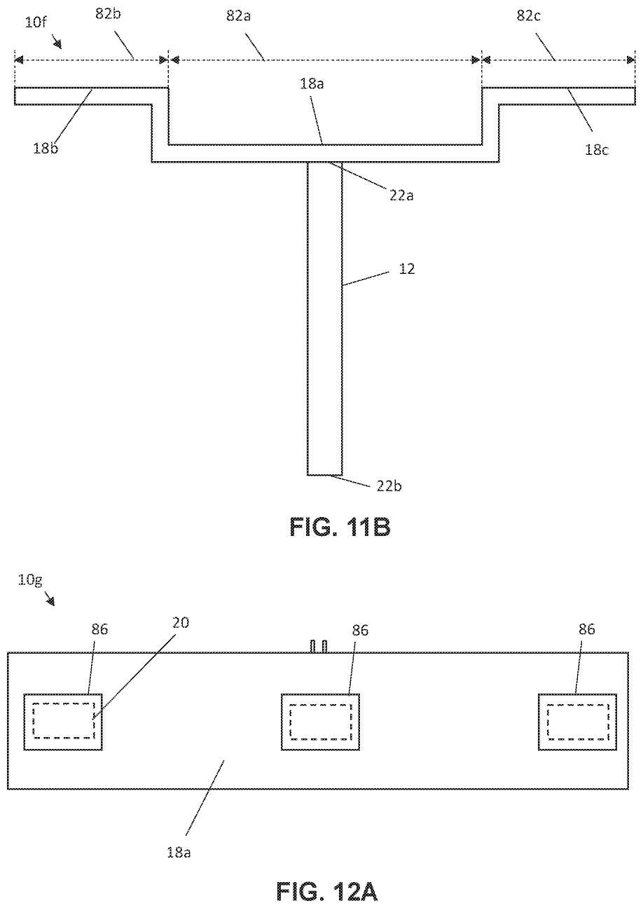

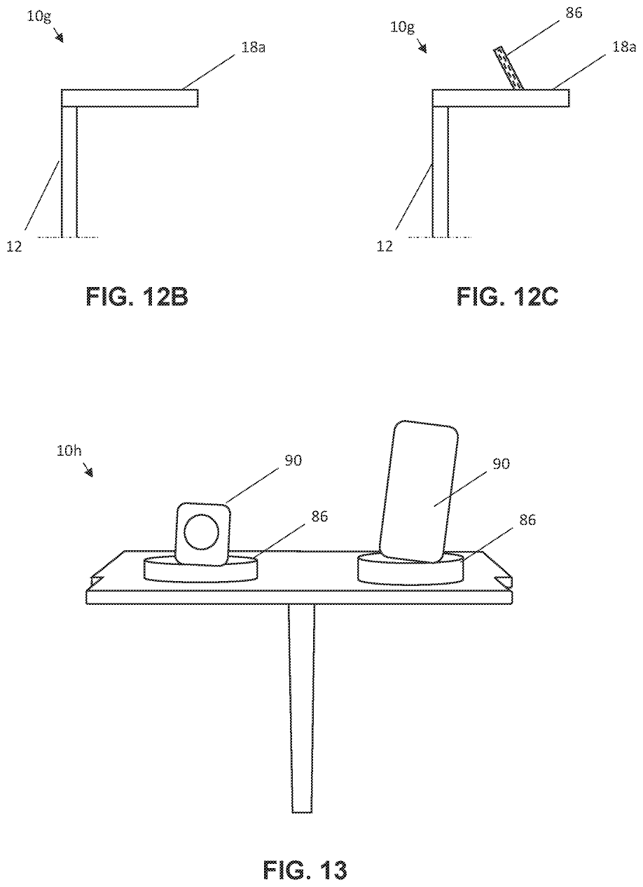

Some of the present charging devices can facilitate a user's continued use of an electronic device while the device is charging, such as by facilitating a user's view of the device's screen. For example, referring to FIGS. 12A-12C, shown is a seventh embodiment (charging device 10g) of the present charging devices that is substantially the same as charging device 10a, the primary exception being that charging device 10g comprises one or more charging stand(s) 86. Each of charging stand(s) 86 can be coupled to one of planar surface(s) 18a of platform 16 and can be configured to hold an electronic device (e.g., a phone or tablet) such that the device is angularly disposed relative to the planar surface, thereby allowing a user to readily view the device. To illustrate, each of stand(s) 86 can have a surface be movable between two positions: a first position in which the stand is substantially parallel to planar surface 18a (FIGS. 12A and 12B) and a second position in which the surface of the stand is angularly disposed relative to the planar surface (FIG. 12C), such as at an angle that is greater than or equal to any one of, or between any two of, 15, 20, 25, 30, 35, 40, 45, 50, 55, or 60 degrees relative to the planar surface. Each of charging stand(s) 86 can comprise at least one of charger(s) 14, such as at least one of inductive charger(s) 20, such that the charging stand can inductively charge an electronic device it is supporting.

Referring to FIG. 13, which shows a charging device 10h that is substantially the same as charging device 10g, charging stand(s) 86 can be fixed such that an electronic device (e.g., 90) it supports may be better viewed by a user while charging.

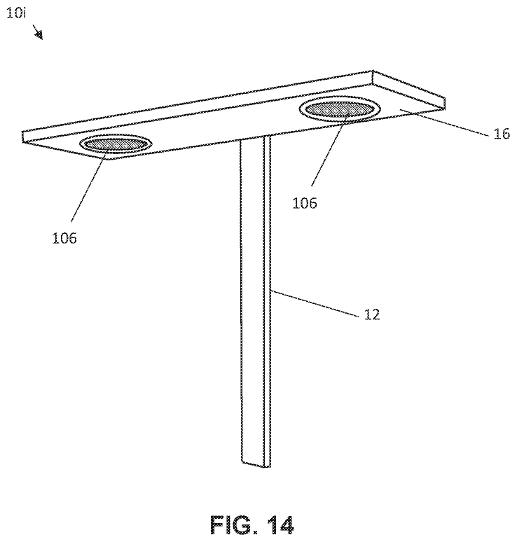

Referring to FIG. 14, some of the present charging devices can include one or more features to enhance a user's experience. As shown, for example, charging device 10i—which is substantially the same as charging device 10a—can include one or more speakers 106 configured to produce sounds transmitted to the charging device by one of the electronic device(s) it supports and/or charges (e.g., over Bluetooth®, a USB connection, an audio cable, and/or the like). Charging device 10i can include a power button and/or one or more buttons to adjust the volume of speaker(s) 106.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A charging device comprising:
a plug;
a platform defining one or more planar surfaces;
a leg having:
a bottom end coupled to the plug and a top end coupled to the platform;
a length measured between the top and bottom ends; and
a minimum width that is less than one-third of a width of the platform, the minimum width of the leg and the width of the platform each measured perpendicularly to the length of the leg; and
one or more chargers;
wherein the plug is configured to be received into a receptacle on a wall such that:
the one or more chargers are in electrical communication with the receptacle;
the leg extends between the receptacle and the platform along the wall; and
the platform projects outwardly from the wall such that each of the one or more planar surfaces is substantially perpendicular to the wall and the width of the platform is substantially parallel to the wall.

2. The charging device of claim 1, further comprising one or more wires disposed within the leg, the one or more wires in electrical communication with the one or more chargers and with the plug.

3. The charging device of claim 1, wherein the minimum width of the leg is less than or equal to one-fifth of the length of the leg.

4. The charging device of claim 3, wherein the minimum width of the leg is between 0.60 and 2.75 inches.

5. The charging device of claim 1, wherein the length of the leg is at least 1 foot.

6. The charging device of claim 1, wherein a width of the leg, measured perpendicularly to the length of the leg, is substantially constant along the length of the leg.

7. The charging device of claim 1, wherein a surface area of the one or more planar surfaces is at least 0.5 square foot.

8. The charging device of claim 1, wherein:
the one or more planar surfaces of the platform comprise three or more planar surfaces,
a first planar surface of the three or more planar surfaces is coupled to the leg along a first direction aligned with the minimum width of the leg and is disposed between a second planar surface and a third planar surface of the three or more planar surfaces; and
the second and third planar surfaces are disposed further from the bottom end of the leg than the first planar surface and are arranged along a second direction aligned with the length of the leg.

9. The charging device of claim 1, wherein the one or more chargers comprise one or more inductive chargers, each inductive charger of the one or more inductive chargers configured to inductively charge a device disposed on a respective planar surface of the one or more planar surfaces of the platform.

10. The charging device of claim 1, wherein the one or more chargers comprise one or more charging receptacles, each charging receptacle of the one or more charging receptacles positioned closer to the top end of the leg than to the bottom end of the leg.

11. The charging device of claim 10, wherein at least one charging receptacle of the one or more charging receptacles is coupled to the leg.

12. The charging device of claim 10, wherein at least one charging receptacle of the one or more charging receptacles is coupled to a particular planar surface of the one or more planar surfaces of the platform.

13. The charging device of claim 1, wherein the one or more chargers comprise one or more charging stands, each charging stand of the one or more charging stands coupled to a respective planar surface of the one or more planar surfaces of the platform and configured to inductively charge and hold a device such that the device is angularly disposed relative to the respective planar surface.

14. The charging device of claim 13, wherein each charging stand of the one or more charging stands includes a surface that is movable between a first position in which the surface is substantially parallel to a respective planar surface of the one or more planar surfaces and a second position in which the surface is angularly disposed relative to the respective planar surface.

15. The charging device of claim 1, further comprising one or more brackets configured to be coupled to the leg and defining two openings, wherein the one or more brackets are configured to be secured to the wall by a corresponding fastener received through each opening of the two openings, and wherein when each bracket is secured to the wall each bracket of defines a space configured to receive the leg.

16. The charging device of claim 1, further comprising one or more adhesive strips, each having a width that is less than the minimum width of the leg.

17. The charging device of claim 1, further comprising one or more compartments, each positioned closer to the top end of the leg than to the bottom end of the leg.

18. The charging device of claim 17, wherein:
the leg includes a tapered portion coupled to the platform in which a width of the leg, measured perpendicular to the length of the leg, decreases moving along the length of the leg toward the bottom end of the leg; and
the tapered portion includes the one or more compartments.

19. The charging device of claim 17, wherein the one or more chargers comprise:
one or more inductive chargers, each inductive charger of the one or more inductive chargers configured to inductively charge a device disposed in a respective compartment of the one or more compartments; and/or
one or more charging receptacles, each charging receptacle of the one or more charging receptacles positioned in a respective compartment of the one or more compartments.

20. The charging device of claim 1, wherein the plug comprises three prongs.
